(19) United States
(12) Patent Application Publication
(10) Pub. No.: US 2006/0072481 A1
(43) Pub. Date: Apr. 6, 2006

(54) Apparatus and method to facilitate mobility management

(75) Inventors: Alex P. Hirsbrunner, Bloomingdale, IL (US); Mark D. Hamlen, Palatine, IL (US); Ajaykumar R. Idnani, Schaumburg, IL (US); Steven D. Upp, Bartlett, IL (US); Kamala D. Urs, Arlington Heights, IL (US); Les P. Vietzke, Ada, MI (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/955,474

(22) Filed: Sep. 30, 2004

(51) Int. Cl. H04L 12/28

(52) U.S. Cl. 370/254; 370/352

(57) ABSTRACT

Information regarding the present location of a dual-mode (or multi-mode) mobile station with respect to a plurality of communication systems is timely maintained by facilitating automated contact information modifications via, for example, a mobility management server (30). In a preferred approach, upon receiving a message (11) evidencing the supported presence of a mobile station in a first communication system comprising a wireless wide area network, one automatically responds (12) by modifying such contact information as is retained in a Session Initiation Protocol registrar. Testing (21) can be utilized to assure the propriety of making such alterations and/or deletions.

### TECHNICAL FIELD

This invention relates generally to communication systems and more particularly to multi-system mobility.

### BACKGROUND

Communication systems, including wireless communication systems, are well known in the art. These include a variety of protocols and technologies that support a variety of voice and data services. Some systems, including wireless wide area networks such as a typical cellular telephony communication system, provide communication services over and through a relatively large coverage area. Other systems, including wireless local area networks such as an 802.11-family of radio frequency (RF) technologies, provide communication access over a considerably reduced area of service.

As technology improves and as users of such services become better versed in the use of their equipment, the demand for increased access and/or options grows along with the ability to meet such demand. For example, serious interest now exists in (and operating examples are found of) a mobile station that can selectively operate compatibly with either a wireless wide area network (e.g. a cellular network) or a wireless local area network. Such a device offers a variety of interesting options and opportunities for subscribers and system administrators alike.

Unfortunately, simply providing such dual capabilities within a single housing does not necessary result in a satisfactory result. Managing the transition from one system to the other (during movement of the mobile station, for example) presents considerable challenge. Though such a hand-off scenario might seem akin to, for example, a cellular system hand-off from one cell to another, significant differences exist. For example, the relative size of the coverage area for a given wireless local area network is considerably smaller than a typical cell site. As one illustration, even while simply moving at an ordinary walking pace, a subscriber can escape the coverage area of the wireless local area network before a hand-off to the wireless wide area network can be smoothly effected.

Relatively complicated algorithms have been proposed to try and meet such needs. Such approaches typically attempt to predict wireless local area network coverage a short time into the future. When one detects that a mobile station is about to seemingly leave the wireless local area network, the mobile station attempts to register with a wireless wide area network to permit continued communications services.

In many instances, however, registration with one system does not necessary accord synchronously with de-registration in the first system. Should a communication seeking that subscriber arrive at this point in time, the overall system will likely seek, and fail to locate, the subscriber within the wireless local area network. This results in wasted system resources, missed or delayed calls, and dissatisfied system users.

### BRIEF DESCRIPTION OF THE DRAWINGS

The above needs are at least partially met through provision of the apparatus and method to facilitate mobility management described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention;

FIG. 4 comprises a flow diagram as configured in accordance with various embodiments of the invention;

FIG. 5 comprises a timing diagram as configured in accordance with various embodiments of the invention;

FIG. 6 comprises a timing diagram as configured in accordance with various embodiments of the invention; and

FIG. 7 comprises a timing diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, upon receiving a message that evidences a supported presence of a given mobile station by a wireless wide area network, an appropriate network entity automatically responds by at least modifying information regarding supported presence of the given mobile station by a wireless local area network via a Session Initiation Protocol registrar.

In a preferred approach the appropriate network entity comprises a mobility management server. The information modification noted above can comprise, when appropriate, deletion of information (such as information comprising wireless local area network contact information as corresponds to the given mobile station) in the Session Initiation Protocol registrar.

Pursuant to an optional but preferred approach, this response further comprises responding to a message (comprising, in at least some instances, a preliminary message) indicating that the given mobile station is now supported by the wireless wide area network by testing whether the given mobile station is subsequently supported by the wireless local area network and/or by the wireless wide area network. Upon determining that the given mobile station is not subsequently supported by the wireless wide area network (as can occur when the mobile station has quickly returned to the wireless local area network), this response can comprise not automatically modifying such contact information.

In some systems the above-mentioned preliminary message may comprise a so-called Cancel Location message (as sourced, for example, by a home location register in accord with well understood prior art practice). In such a case, upon determining that the given mobile station is subsequently supported by the wireless wide area network, this process can eschew automatic modification of the mobile station information and can further prompt the transmission of a denial message as a response to the Cancel Location message. Such action can serve, for example, to avoid or at least ameliorate a so-called race condition that can occur under some operating conditions.

These processes are readily implemented with relatively little impact on the overall throughput capability of either the wireless wide area network or the wireless local area network. These processes are further readily implemented with only modest changes to certain participating network elements and, for the most part, can utilize existing protocols and messages to facilitate these teachings.

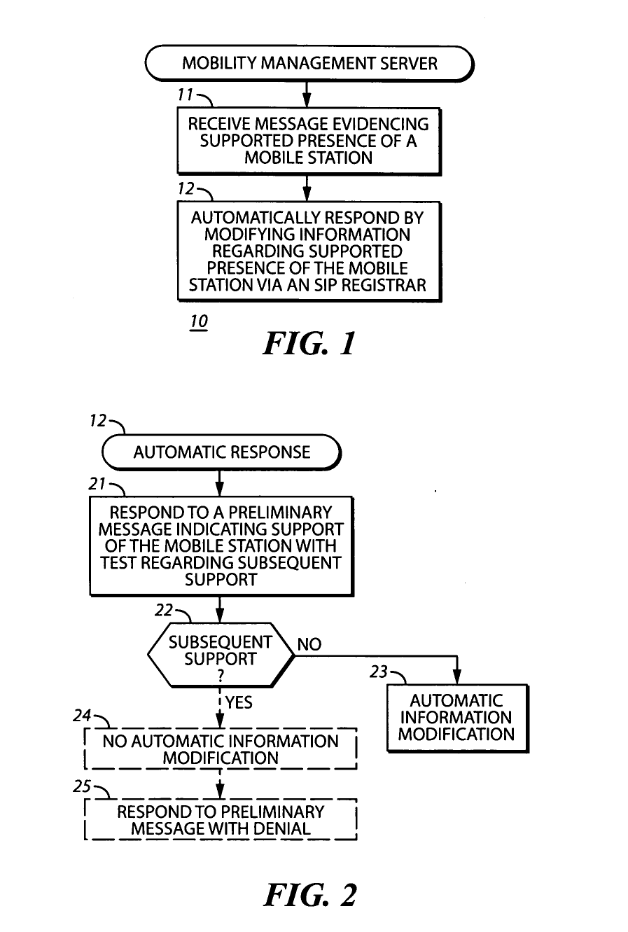

These and other benefits may become more evident upon making a thorough review and study of the following detailed description. Referring now to the drawings, and in particular to FIG. 1, a corresponding process 10 (as implemented, for example, by a network entity such as a mobility management server (MMS)) supports reception 11 of a message that evidences a supported presence of a given mobile station by a wireless wide area network. Such a message may comprise, for example, in some settings, a Session Initiation Protocol (SIP) message. This process 10 then provides for an automatic response 12 to such a message by at least modifying information regarding supported presence of the given mobile station by a wireless local area network via a Session Initiation Protocol registrar (the latter being well known and understood in the art).

For example, pursuant to some settings, this modification can comprise deleting specific information from the Session Initiation Protocol registrar. More specifically, the process 10 can effect a response comprising provision of a message to the Session Initiation Protocol registrar (such as a Session Initiation Protocol message) that itself comprises an instruction to delete wireless local area network contact information as corresponds to the given mobile station from the Session Initiation Protocol registrar's register.

So configured, this surrogate-based eradication of wireless local area network contact information from the Session Initiation Protocol registrar in response to determining that the corresponding mobile station is now being supported by a wireless wide area network essentially ensures that subsequent messages intended for the mobile station are attempted via the wireless wide area network instead of the wireless local area network. This updated sense of the mobile station's present service-based location can occur considerably faster than would ordinarily be expected using prior methodologies. This, in turn, aids in avoiding or at least mitigating misallocated resources, failed calls, and the like.

Referring now to FIG. 2, the above-noted automated response 12 can therefore comprise responding to a preliminary message (such as a Cancel Location message as may be transmitted by a home location register and which is further referred to below) that indicates that the given mobile station is now supported by (or in the process of being supported by) the wireless wide area network by testing 21 whether the given mobile station is subsequently (i.e., subsequent to when that message was sourced) supported by the wireless local area network. There are various ways to effect such testing. As one example, such testing can comprise transmitting one or more test messages to the given mobile station (such as, but not limited to, an appropriate test Session Initiation Protocol message). Upon determining 22, based upon such testing, that the given mobile station is not supported by the wireless local area network, this automatic response can, as described above, then comprise modification 23 of the contact information as stored at the Session Initiation Protocol registrar.

Under some operating conditions, an error case can potentially develop (due, for example, to a so-called race condition). In particular, the mobile station may be appearing to leave the coverage area of the wireless local area network, or may only briefly leave such coverage, but in fact remain within (or quickly return to) the wireless local area network coverage zone. When this occurs, deletion of the give mobile station's wireless local area network contact information from the Session Initiation Protocol registrar may be counter-productive.

Therefore, and with continued reference to FIG. 2, upon determining 22 that the given mobile station is, in fact, presently (and still) supported by the wireless local area network, this process can optionally further comprise not automatically modifying the contact information 24 and/or responding 25 to the above-mentioned preliminary message with a denial message. (Examples are provided below.)

These various actions and responses can be effected as a function of a single testing of present support or can, if desired, be effected as a function of separate discrete testing actions. Examples of separated testing actions are presented below.

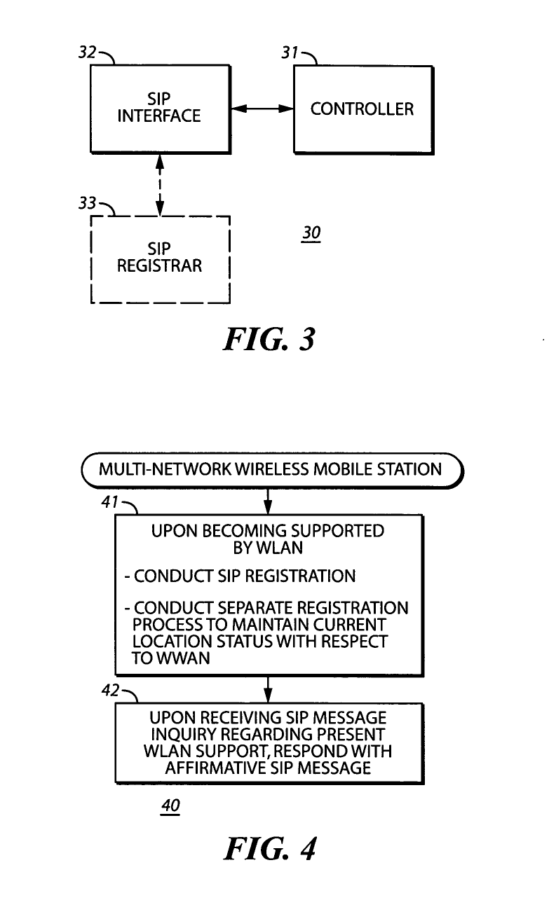

The above-described actions and response can be implemented in any of a variety of ways. By one approach, and referring now to FIG. 3, a mobility management server 30 can comprise a controller 31 that operably couples to a Session Initiation Protocol interface 32 and that is configured and arranged (for example, via appropriate programming) to be responsive to an input indicating that a given mobile station is being supported by a wireless wide area network and to provide an output that comprises an instruction to, for example, a Session Initiation Protocol registrar 33 to at least alter (or, more preferably, delete) a contact record with respect to that given mobile station (which contact record otherwise indicates that the mobile station is located within the service area of a corresponding wireless local area network).

In a preferred implementation, a multi-network wireless mobile station is configured and arranged to effect and/or respond in a particular manner. To illustrate, and referring now to FIG. 4, a corresponding process 40 comprises, at step 41 and when the mobile station becomes supported by a wireless local area network, both conducting a registration process as corresponds to service by the wireless local area network (such as, for example, a Session Initiation Protocol registration process) and conducting a separate registration process as corresponds to the wireless wide area network to at least maintain substantially current location status with respect to the wireless wide area network. This process 40 also preferably supports, upon receiving a Session Initiation Protocol message inquiry as corresponds to whether support by the wireless local area network presently exists, responding 42 with a Session Initiation Protocol message indicative of affirmation. So configured, those skilled in the art will appreciate that a multi-network wireless mobile station will nevertheless be suitably supportive of the various teachings set forth herein.

A number of illustrative examples will now be presented to further illustrate protocols, deployments, and/or behaviors and functionality as accords in various ways with these teachings. For purposes of illustration and not limitation, these examples presume a dual-mode mobile station (DMMS) that is capable of compatible operations in both a wireless local area network supported, in part, by a Session Initiation Protocol (SIP)-compatible network, and a Global System for Mobile Communication (GSM) wireless wide area network. Those skilled in the art will readily recognize that other systems and platforms, presently known and/or hereafter-developed, could substitute with similar expected benefits.

### EXAMPLE 1

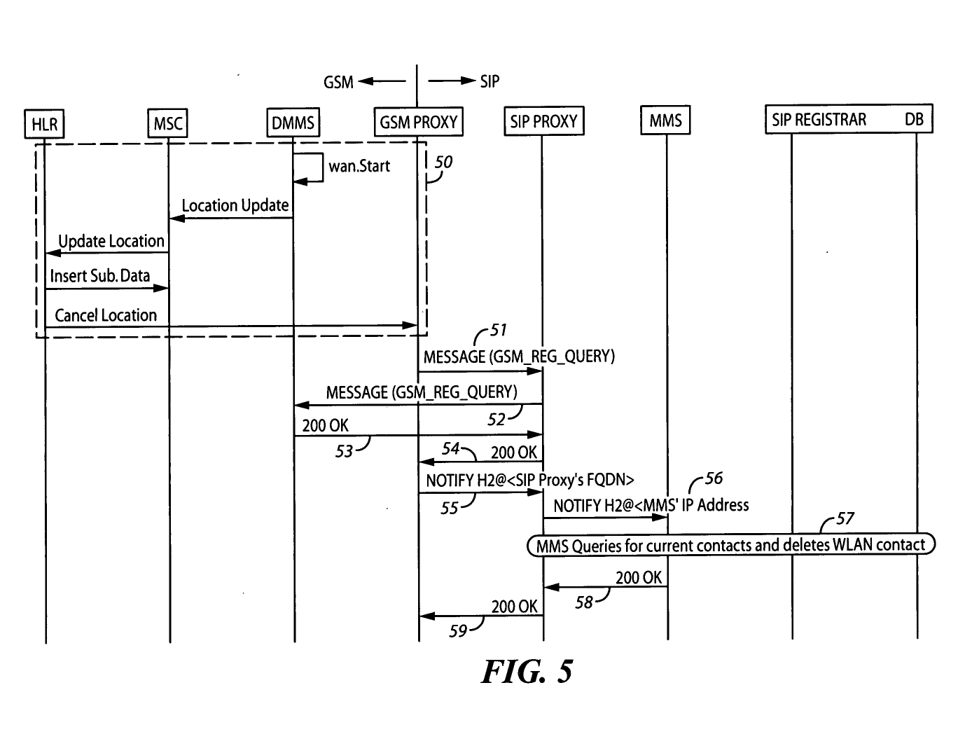

Referring now to FIG. 5, and in accordance with present practice 50, upon initiation of seeking support within the GSM system the mobile station will transmit a Location Update message to a corresponding mobile switching center (MSC) which in turn conducts an Update Location transaction on behalf of the mobile station with a home location register (HLR) as corresponds to that mobile station. The home location register then transmits, in ordinary course, a Cancel Location message to a GSM proxy.

Presuming for the purposes of explanation and example that the SIP-based network includes an SIP proxy as is fairly typical, the GSM proxy then preferably transmits an SIP message 51 comprising, in this example, a GSM_REG_QUERY message, to the SIP proxy. Upon receiving this message, the SIP proxy transmits, via the SIP-based network, a GSM_REG_QUERY message 52 to the mobile station on behalf of the GSM proxy. In this example, as the mobile station is indeed effecting a switch to the GSM system, the mobile station responds, in accord with present practice, with a 200 OK SIP message 53. The SIP proxy then forwards a corresponding 200 OK message 54 to the GSM proxy.

In this example the GSM proxy then transmits another SIP message 55 to the SIP proxy comprising a NOTIFY identifier@<X> message (where “X,” in this embodiment comprises the fully qualified domain name (FQDN) for the SIP proxy). The purpose of this message, of course, is to further effect and/or confirm registration of the mobile station with the GSM system. Pursuant to these teachings, the SIP proxy, in such an instance, is configured and arranged to then transmit a corresponding NOTIFY identifier@<Y> message 56 wherein the “Y,” in this example, comprises the Internet Protocol address for a mobility management server (MMS) that is configured and arranged to comport with and implement the teachings set forth above. (Those skilled in the art will readily recognize and understand that such a mobility management server can comprise a separate and discrete network entity platform or can be integrated with, or distributed over, other physical platforms as may be desired in a given deployment.)

In this example, the mobility management server then queries 57 the SIP registrar for current contact information between the SIP-based network and the mobile station and, upon confirming the absence of the mobile station and/or a positive confirmation that the mobile station is indeed effecting a switch to the GSM system, deletes the contact information regarding the mobile station from the corresponding SIP Registrar database (DB).

Upon effecting these actions, the mobility management center then, in this example, transmits a 200 OK message 58 to the SIP proxy which in turn transmits a corresponding 200 OK message 59 to the GSM proxy, hence concluding this overall transaction.

So configured and arranged, it can be seen that the contact records as correspond to the mobile station's presence within the SIP-based wireless local area network are rapidly and accurately updated to reflect the present absence of the mobile station upon switching to the GSM system. This, in turn, permits timely management of subsequent call (and other) activity that depends upon accurate multi-system location information for individual mobile stations.

### EXAMPLE 2

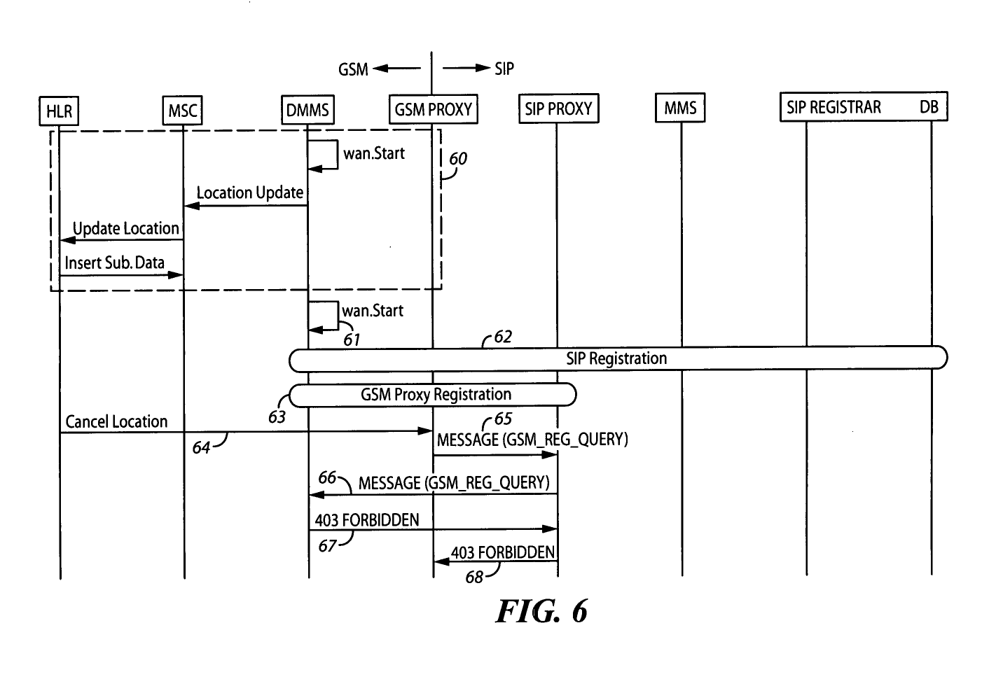

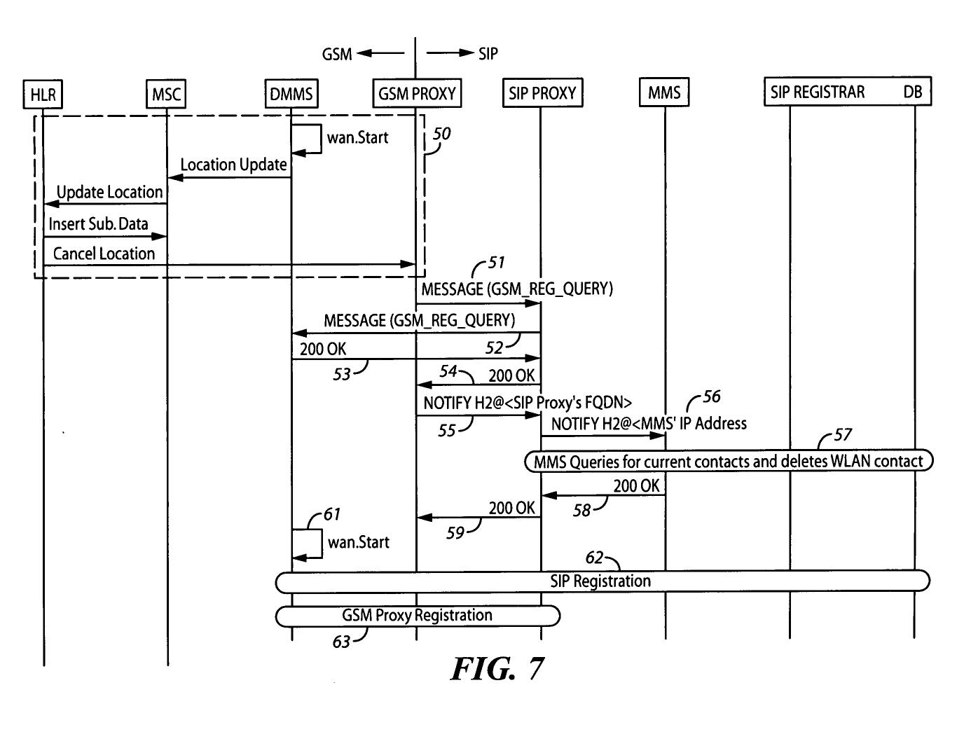

In this example, and referring now to FIG. 6, the dual-mode mobile station again initiates 60 its registration activities with the GSM system as can occur, for example, when the dual-mode mobile station operates near the fringe of the wireless local area network. In this example, however, the dual-mode mobile station subsequently determines that a switch to the GSM system is presently unnecessary and instead effects a new SIP registration process 62 and a GSM proxy registration process 63 (both in accord with known procedures in this example).

In this example, however, the home location register transmits its Cancel Location message 64 to the GSM proxy subsequent to the above events being accomplished. Such a delay and resultant sequence of events (sometimes referred to as a race condition) can happen for a variety of reasons and, in fact, constitutes a not infrequent occurrence. In ordinary practice, this Cancel Location message 64 would have the potential to ultimately cause the dual-mode mobile station to be de-registered from the SIP registrar notwithstanding the fact that the mobile station is presently successfully operating in the wireless local area network and is not, in fact, presently switching to the GSM system.

Pursuant to these teachings, however, and as described above in Example 1, the GSM proxy will respond to the Cancel Location message 64 by transmitting a GSM_REG_QUERY message 65 to the SIP proxy which will in turn transmit a corresponding GSM_REG_QUERY message 66 to the dual-mode mobile station itself. Knowing its own operational status, and pursuant to a preferred approach in this regard, the dual-mode mobile station can respond with a Session Initiation Protocol message such as a 403 FORBIDDEN message 67, which the SIP proxy can forward 68 to the GSM proxy to effectively terminate the attempted effort to cancel the location information as corresponds to the mobile station.

So configured, the current contact information as corresponds to the mobile station and as is stored in the SIP registrar will not be inappropriately discarded as a result of a race condition. Of course, when the mobile station is in fact continuing to switch to the GSM system, the process can instead continue as described above with respect to EXAMPLE 1.

### EXAMPLE 3

This last example simply illustrates that once a dual-mode mobile station has left the wireless local area network and switched to the GSM system (as per actions and messages denoted by reference numerals 50 through 59, which actions and messages have already been described above with reference to FIG. 5), upon again returning to the coverage area of the wireless local area network, the dual-mode mobile station can effect the actions and messages denoted by reference numerals 61 through 63 (which actions and messages have already been described above with reference to FIG. 6). So configured, it can be seen and appreciated that these teachings to not otherwise conflict with the ordinary and expected movements, affiliations, and re-affiliations of a dual-mode mobile station.

Again, those skilled in the art will understand and appreciate that these teachings, employed in conjunction with two or more wireless communication systems, will effectively tend to ensure that contact information as corresponds to a given multi-mode mobile station will be timely updated (and especially deleted or otherwise characterized as inactive or absent) to aid in ensuring that subsequent location-dependent messages and actions are well informed and effectively facilitated.

Those skilled in the art will further recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
receiving a message that evidences a supported presence of a given mobile station by a wireless wide area network;
automatically responding to the message by at least modifying information regarding supported presence of the given mobile station by a wireless local area network via a Session Initiation Protocol registrar.

2. The method of claim 1 wherein receiving a message further comprises receiving a Session Initiation Protocol message.

3. The method of claim 1 wherein modifying information further comprises deleting the information via the Session Initiation Protocol registrar.

4. The method of claim 1 wherein automatically responding to the message further comprises providing a second message to the Session Initiation Protocol registrar.

5. The method of claim 4 wherein the second message further comprises a Session Initiation Protocol message.

6. The method of claim 5 wherein the Session Initiation Protocol message comprises an instruction to delete the wireless local area network contact information as corresponds to the given mobile station.

7. The method of claim 1 wherein automatically responding to the message further comprises:
responding to a preliminary message indicating that the given mobile station is now supported by the wireless wide area network by testing whether the given mobile station is subsequently supported by the wireless local area network;
upon determining that the given mobile station is not subsequently supported by the wireless local area network, automatically modifying the information.

8. The method of claim 7 wherein testing further comprises transmitting a test message.

9. The method of claim 8 wherein transmitting a test message further comprises transmitting a test message to the given mobile station.

10. The method of claim 9 wherein transmitting a test message to the given mobile station further comprises transmitting a test Session Initiation Protocol message to the given mobile station.

11. The method of claim 7 and further comprising:
upon determining that the given mobile station is subsequently supported by the wireless local area network, not automatically modifying the information.

12. The method of claim 11 and further comprising:
upon determining that the given mobile station is subsequently supported by the wireless local area network, responding to the preliminary message with a denial message.

13. A method for use by a wireless mobile station capable of compatible operations in either of a wireless wide area network and a wireless local area network, comprising:
upon becoming supported by the wireless local area network:
conducting a Session Initiation Protocol registration process as corresponds to service by the wireless local area network;
conducting a separate registration process as corresponds to the wireless wide area network to at least maintain substantially current location status with respect to the wireless wide area network;
upon receiving a Session Initiation Protocol message inquiry as corresponds to whether support by the wireless local area network presently exists, responding with a Session Initiation Protocol message indicative of affirmation.

14. An apparatus comprising:
a Session Initiation Protocol interface;
a controller operably coupled to the Session Initiation Protocol interface and being responsive to an input indicating that a given mobile station is being supported by a wireless wide area network and having an output that comprises an instruction to a Session Initiation Protocol registrar to at least alter a contact record with respect to the given mobile station.

15. The apparatus of claim 14 wherein the controller further comprises means for communicating with the Session Initiation Protocol registrar using Session Initiation Protocol.

16. The apparatus of claim 14 wherein the controller further comprises means for deleting an existing contract record as corresponds to the given mobile station.
